(19) United States
(12) Patent Application Publication
(10) Pub. No.: US 2006/0162516 A1
(43) Pub. Date: Jul. 27, 2006

(54) Hair trimmer

(75) Inventors: Matthew L. Andis, Racine, WI (US); Richard J. Tringali, Racine, WI (US); Robert E. Derby, Racine, WI (US); Andrew A. Skuhra, Racine, WI (US)

Correspondence Address: MICHAEL BEST & FRIEDRICH, LLP, 100 E WISCONSIN AVENUE, MILWAUKEE, WI, 53202, US

(73) Assignee: Andis Company, Racine, WI (US)

(21) Appl. No.: 11/389,792

(22) Filed: Mar. 27, 2006

Related U.S. Application Data
(63) Continuation-in-part of application No. 11/231,013, filed on Sep. 20, 2005.
Application No. 11/231,013 is a continuation of application No. 10/285,390, filed on Oct. 31, 2002, now Pat. No. 6,948,248.

(51) Int. Cl. B26D 1/00; B26B 19/00

(52) U.S. Cl. 83/13; 30/34.05

(57) ABSTRACT

A hair trimmer includes a body portion having a cutting end, the body portion defining a cavity and an opening communicating with the cavity, and a blade set mounted adjacent the cutting end. The hair trimmer includes an ion emitter assembly at least partially mounted within the cavity, wherein ions emitted from the ion emitter assembly flow generally toward the cutting end. A collection container is at least partially disposed within the body portion for collecting trimmed hair as it is cut by the blade set.

### CROSS-REFERENCE TO RELATED APPLICATION

This application is a continuation-in-part of U.S. patent application Ser. No. 11/231,013, entitled “HAIR TRIMMER”, filed Sep. 20, 2005 by Matthew L. Andis, Richard J. Tringali, and Robert E. Derby, which is a continuation of U.S. patent application Ser. No. 10/285,390, entitled “HAIR TRIMMER”, filed Oct. 31, 2002 and issued as U.S. Pat. No. 6,948,248 on Sep. 27, 2005, by Matthew L. Andis, Richard J. Tringali, and Robert E. Derby.

### BACKGROUND OF THE INVENTION

The invention relates to methods and apparatus for trimming hair.

Various methods and apparatus for trimming hair have been used in the past. Nevertheless, a new method and apparatus for trimming hair that provides enhanced hair care results would be welcomed by those that utilize hair trimmers.

### SUMMARY OF THE INVENTION

In one embodiment, the invention provides a hair trimmer including a body portion having a cutting end, the body portion defining a cavity and an opening communicating with the cavity, and a blade set mounted adjacent the cutting end. The hair trimmer also includes an ion emitter assembly at least partially mounted within the cavity, wherein ions emitted from the ion emitter assembly flow generally toward the cutting end. A collection container is at least partially disposed within the body portion for collecting trimmed hair as it is cut by the blade set.

In another embodiment, a hair trimmer includes a body portion having a cutting end. The body portion defines a cavity and an opening communicating with the cavity, wherein the opening is separate from the cutting end. A blade set is mounted adjacent the cutting end. The hair trimmer also includes an ion emitter assembly at least partially mounted within the cavity, wherein ions emitted from the ion emitter assembly flow generally toward the cutting end. A collection chamber is at least partially disposed within the body portion, and a vacuum source is disposed within the cavity and in communication with the opening and the collection chamber. The vacuum source draws trimmed hair as it is cut by the blade set into the collection chamber.

In yet another embodiment, the invention provides a hair trimmer including a body portion having a cutting end, the body portion defining a cavity and an opening communicating with the cavity, wherein the opening is separate from the cutting end. A separation member is disposed in the cavity for dividing the cavity into a first chamber and a second chamber, wherein the opening communicates with the second chamber. A blade set is mounted adjacent the cutting end. The hair trimmer also includes an ion emitter assembly at least partially mounted within the cavity, wherein ions emitted from the ion emitter assembly flow generally toward the cutting end and through the opening. A vacuum source is disposed within the cavity and in communication with the opening and the second chamber, wherein the vacuum source draws trimmed hair as it is cut by the blade set into the second chamber.

In one embodiment, the invention provides a method for trimming hair using a hair trimmer. The hair trimmer includes a body portion having a cutting end, the body portion defining a cavity and an opening communicating with the cavity, a blade set mounted adjacent the cutting end, an electric motor drivingly connected to the blade set, an ion emitter assembly at least partially mounted within the cavity and coupled to the body portion, a collection chamber at least partially disposed within the body portion, and a vacuum source disposed within the cavity and in communication with the opening and the collection chamber. The method of trimming hair includes powering the electric motor to drive the blade set, emitting ions from the ion emitter assembly, wherein the ions pass through the opening and flow generally toward the cutting end, cutting hair with the blade set, and drawing trimmed hairs into the collection chamber with the vacuum source.

Further objects of the present invention together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

FIG. 1 is a perspective view of a hair trimmer of the present invention.

FIG. 2 is a perspective view of another hair trimmer of the present invention.

FIG. 3 is a perspective view of the hair trimmer of FIG. 2 with a portion cut away.

FIG. 4 is a top view of the hair trimmer of FIG. 2 with a portion cut away.

FIG. 5 is a side view of the hair trimmer of FIG. 2 with a portion cut away.

FIG. 6 is a side view similar to FIG. 5 showing an alternative construction of the hair trimmer of FIG. 2.

FIG. 7 is a perspective view of another hair trimmer of the present invention.

FIG. 8 is a side view of the hair trimmer of FIG. 7 with a portion cut away.

FIG. 9 is an exploded end view of another hair trimmer of the present invention including a container for collecting trimmed hair.

FIG. 10 is a perspective view of a hair trimmer of the present invention, including a power switch for an ion emitter assembly.

FIG. 11 is a perspective view of the hair trimmer of FIG. 10 with a portion cut away.

FIG. 12 is a sectional view of the hair trimmer of FIG. 10 taken along line 12-12.

FIG. 13 is a perspective view of a separation member of the hair trimmer.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DETAILED DESCRIPTION

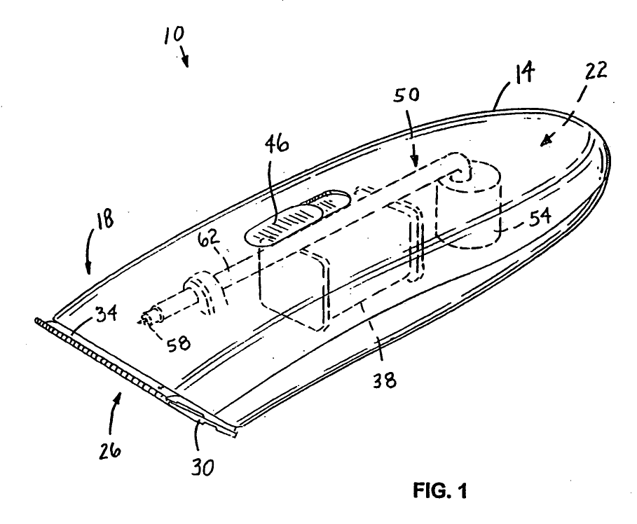

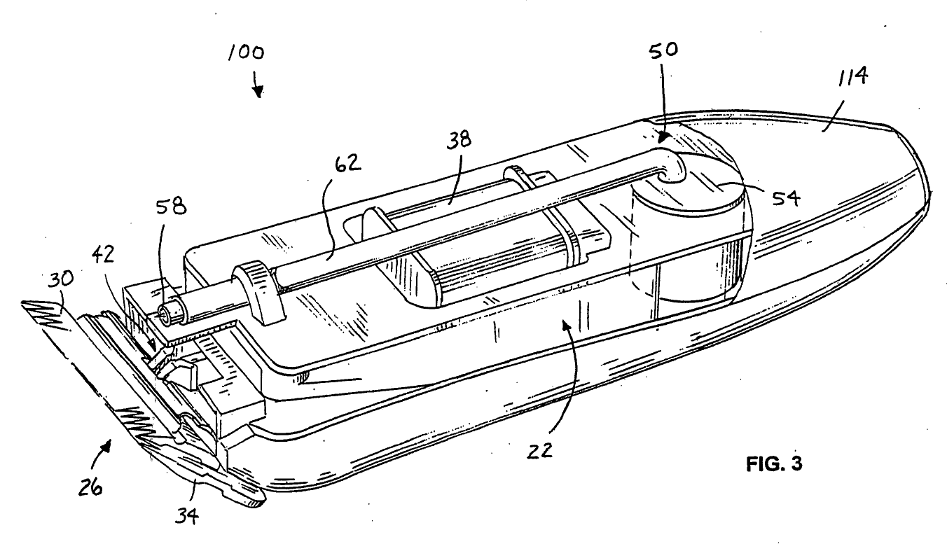

FIG. 1 illustrates a hair trimmer or clipper 10 of the present invention. The hair trimmer 10 includes a hollow, elongated body portion 14 having a cutting end 18 and defining an inner cavity 22. The elongated body 14 supports a blade set 26 on the cutting end 18. The blade set 26 includes a fixed blade 30 mounted on the body portion 14 and a reciprocating blade 34 biased against and moveable with respect to the fixed blade 30 by a drive mechanism 42 (FIGS. 3 and 5). An electric motor or actuator 38 is mounted in the inner cavity 22 and is drivingly connected to the blade set 26 by the drive mechanism 42. The electric motor 38 effects reciprocation of the reciprocating blade 34 with respect to the fixed blade 30 in response to actuation of the motor 38. A user actuates the motor 38 using a power switch 46 provided on the body portion 14. The switch 46 is configured to interrupt the flow of electrical power from a power supply to the electric motor 38. The electrical power may include an alternating current (AC) power provided via a corded plug electrically coupled to a wall outlet and/or a direct current (DC) power provided by a battery (e.g., a rechargeable battery disposed in the cavity 22). Hair trimmers powered by AC and/or DC power are generally known in the art and, accordingly, are not discussed further herein. As the hair trimmer 10 is guided through a person's hair, the reciprocating motion of the blade set 26 cuts the person's hair. A number of suitable blades sets, motors, and driving arrangements are known. It should be appreciated that hair trimmers having other types of blade sets, motors, and/or driving arrangements would be suitable for use in combination with the present invention.

The hair trimmer 10 includes an ion emitting assembly 50 having an ionizer 54, an ion emitting electrode 58, and an ion lead 62 that electrically couples the ionizer 54 and the electrode 58. In some embodiments, as illustrated in FIG. 1, the ionizer 38 is mounted in the cavity 22 and the electrode 42 is mounted near the cutting end 18. In other embodiments, the components 54, 58, and 62 of the ionizer 38 may be alternatively positioned (e.g., the components 54, 58, and 62, or portions thereof, may be mounted alternatively inside the cavity, outside the cavity, or a combination thereof).

For operation, the ionizer 54 receives an ionizer input power from a power source. Similar to the motor 38, the ionizer input power may include an AC power and/or a DC power. In some embodiments, the input power of the motor 38 may be substantially similar to the ionizer input power. In one embodiment, the ionizer input power is provided to the ionizer 54 when the user actuates the switch 46 to an ON position. In another embodiment, a separate ionizer switch (not shown) is provided on the body portion 14. The ionizer switch is configured to interrupt the flow of electrical power (i.e., the ionizer input power) from a power supply to the ionizer 54. Utilization of a separate ionizer switch allows a user to control the ion emitting assembly 50 independent of the motor 38.

The ionizer 54 utilizes the ionizer input power to generate an ionizer output power. In most embodiments, the ionizer output power is a high voltage, low current power. In one embodiment, the ionizer input power is a 120 volt AC power, which is the standard residential electrical service provided in the United States, and the ionizer output power includes a voltage between approximately negative 3.3 kilo-volts DC and negative 4.8 kilo-volts DC and a current of approximately 50 micro-amps. In other embodiments, alternative values of ionizer input and output powers are possible depending on the specific configuration of the ionizer 54.

The electrode 58 receives the ionizer output voltage from the ionizer 54 via the ion lead 62 and emits ions. The length of the ion lead 62 may vary based on location of the electrode 58 with respect to the ionizer 54. In some embodiments, the need for the ion lead 62 may be obviated. In the illustrated embodiment, the ions emitted from the electrode 58 are negative ions. The emitted negative ions are utilized to facilitate hair care process as discussed further below. While the illustrated embodiments are described as emitting negative ions for use in hair care processes, positive ions may be emitted in place of, or in combination with, the negative ions. Additionally, although the illustrated electrode 58 is a needle electrode, other embodiments of the electrode 58 may include alternative shapes (e.g., a plate electrode) and sizes.

In one embodiment, the ion emitting assembly 50 includes ion generator model number SW750H-8 provided by Seawise Industrial Ltd. of Kowloon Hong Kong. The Seawise ion generator utilizes an input power having a voltage of 120 volts AC to generate an output power having a maximum negative voltage of approximately negative 7.5 kilo-volts DC and current of approximately 50 micro-amps. The Seawise ion generator generates negative ions. In other embodiments, the ion emitting assembly 50 may include other configurations of ion generators.

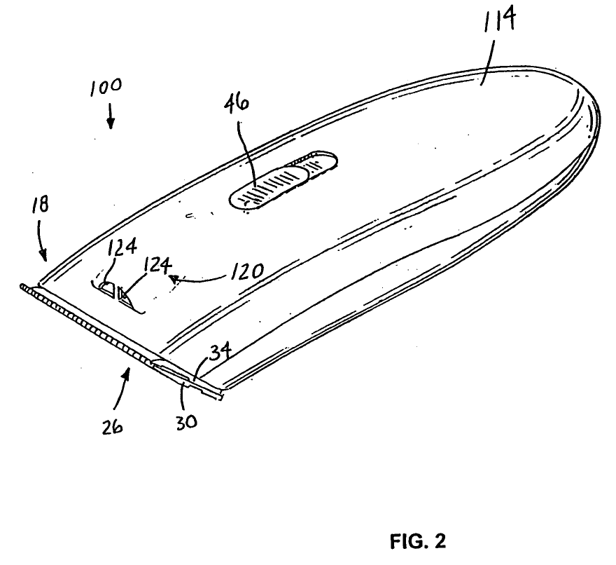

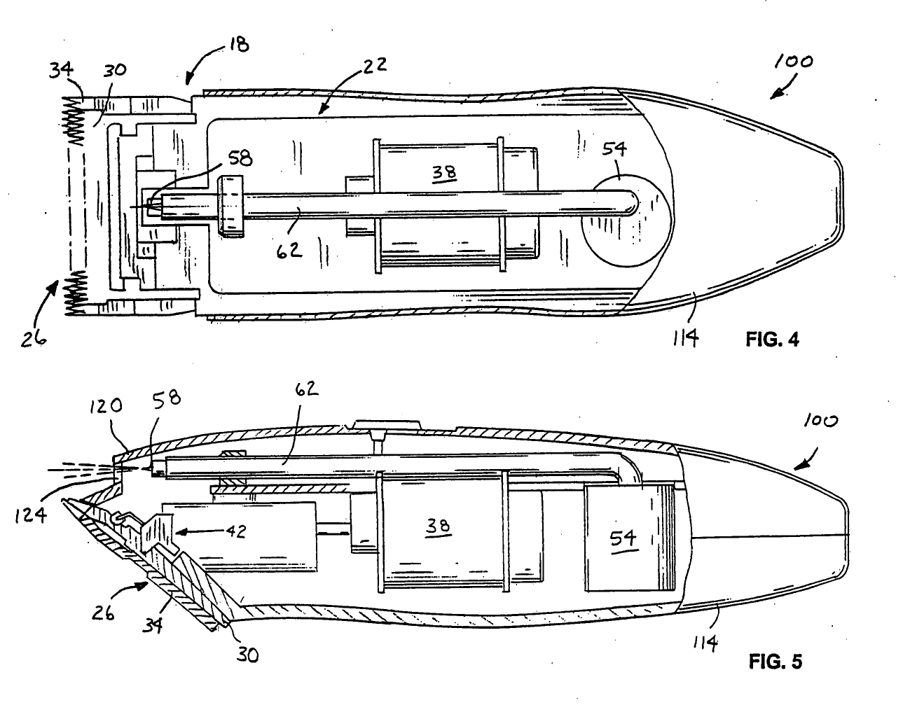

FIGS. 2-5 illustrate a hair trimmer 100. The hair trimmer 100 is similar to the hair trimmer 10 and like parts are identified using the same reference numerals. The hair trimmer 100 includes a body portion 114 that includes a shroud portion 120. The shroud portion 120 defines openings 124 that communicate with the inner cavity 22 and open toward the cutting end 18. The shroud portion 120 substantially surrounds the electrode 58 such that ions emitted from the electrode 58 pass through the openings 124 and flow generally toward the cutting end 18.

In one embodiment, the ions emitted by the electrode 58 of the hair trimmer 100 substantially reduce or eliminate static electricity on a person's hair as the hair trimmer 100 is used to trim the person's hair. Static electricity may cause a person's hair to stand on end, making the hair difficult to manage as well as aesthetically displeasing. Static electricity may be generated due to the motion of a hair trimmer and/or combs and brushes through a person's hair. Additionally, static electricity may be alternatively generated on a person's hair.

As a person's hair is trimmed, the ions emitted from the electrode 58 may be passively and/or actively moved to a person's hair.

In one embodiment, the ions are passively moved to the person's hair via an “ionic wind”. As the ions are emitted from the electrode 58, the emitted ions move outward away from the electrode 58. The continuous movement of ions away from the electrode is known as an “ionic wind”. In some embodiments, the emitted ions are attracted to an object (e.g., the person's hair) with an opposite polarity. The emitted ions travel through electric field lines away from the electrode 58 to the object. The ions then act to neutralize the opposite charge on the object. Neutralization of the opposite charge thereby reduces or eliminates static electricity. In other embodiments, the emitted ions are concentrated on an object, thereby creating a net positive or negative charge on the object.

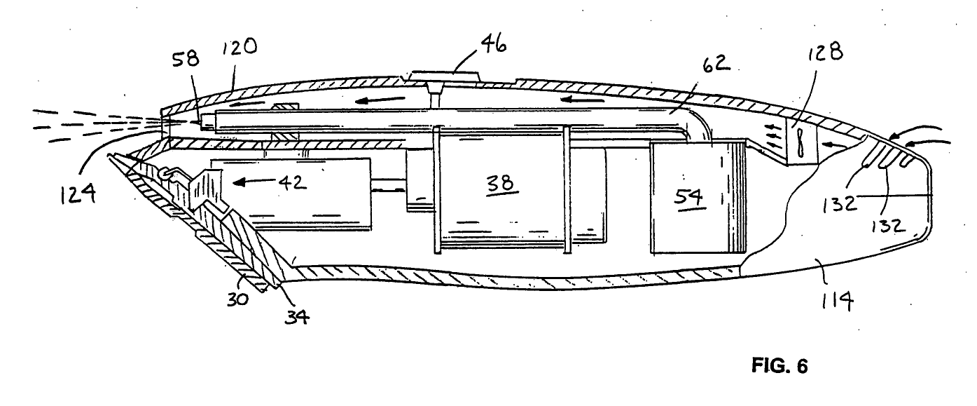

In another embodiment, as shown in FIG. 6, the hair trimmer 100 may include a fan 128 (schematically represented). The fan 128 is utilized to actively move the emitted ions away from the electrode 58 towards the person's hair. The fan 128 draws air in through air vents 132 and moves air through the cavity 22 past the electrode 58 and out the openings 124 in the shroud 120. The movement of air is represented in FIG. 6 with arrows. The cavity 22 may include structure to direct the flow of air through specific parts thereof. The fan 128 assists the passive movement of ions from the electrode 58. The ions are attracted to the person's hair for neutralization of the static electricity, or concentrated on an object resulting in a positive or negative charge on the object, in a similar fashion as discussed above with respect to the passive movement.

In one embodiment, the ions emitted by the electrode 58 of the hair trimmer 100 are utilize to charge the blade set 26 for attraction of the trimmed hairs 128. As the ions are emitted from the electrode 58, the emitted ions collect on the metal blade set 26, thereby charging the blade set 26. The charged blade set 26 attracts objects with an opposite polarity (e.g., the hairs 136 trimmed from a person's hair). As the hairs 136 are trimmed, they are attracted to the blade set 26, thereby reducing or eliminating the hairs 136 from falling on the floor or the person. The degree of charge on the blade set 26 may be controlled to optimize the amount of hair 136 that is attracted. In other embodiments, the blade set 26 is charged to a degree that repels hair from collecting on the blade set 26 but does not interfere with the hair trimming process.

In one embodiment, the ions emitted by the electrode 58 may substantially reduce or eliminate static electricity on a person's hair and charge the blade set 26 for attraction of the trimmed hairs 128. In other embodiments, portions of the blade set 26 are made of an insulating material (e.g., ceramic) to reduce the attraction of the hairs 136.

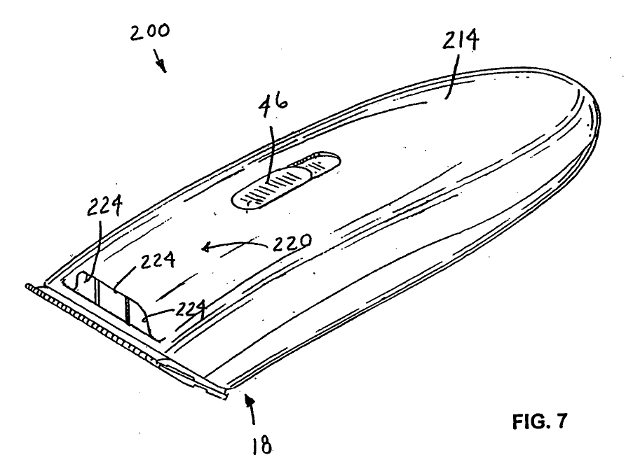

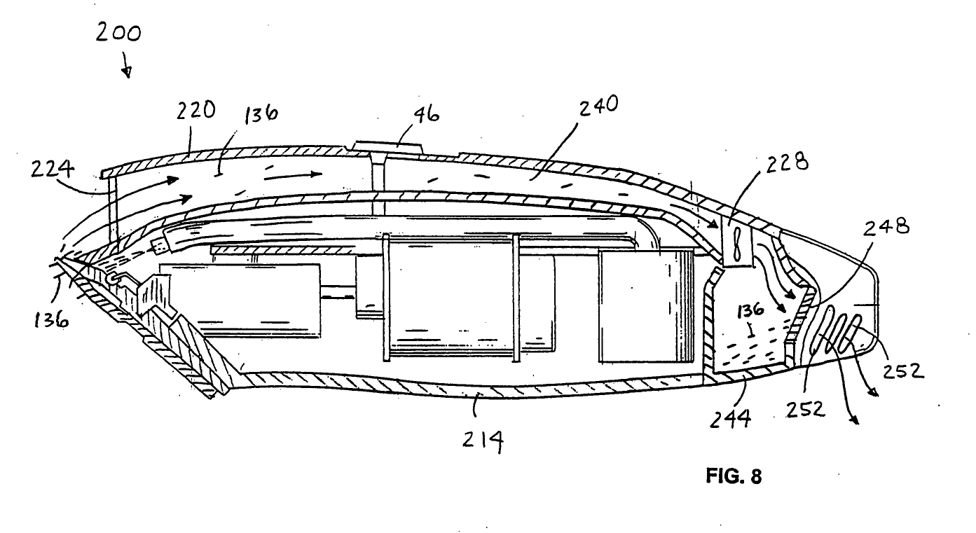

FIGS. 7-8 illustrate a hair trimmer 200. The hair trimmer 200 is similar to the hair trimmers 10 and 100 and like parts are identified using the same reference numerals. The hair trimmer 200 includes a body portion 214 that includes a shroud portion 220. The shroud portion 220 defines openings 224 that communicate with the inner cavity 22 and open toward the cutting end 18. The shroud portion 220 is disposed adjacent to the cutting portion of the blade set 26. In one embodiment, as shown in FIG. 8, the electrode 58 of the ion emitting assembly 50 is angled towards the inboard side of the fixed blade 30. The ions emitted from the electrode 58 are utilized to charge the blade set for attraction of trimmed hairs 136 as discussed above with respect to the hair trimmer 100. In other embodiments, a plate electrode is placed adjacent the inboard side of the fixed blade 30 for attraction of trimmed hairs 136 toward the blade set 26. As operation of the hair trimmer continues 200, a build-up of trimmed hairs 128 may form. The hair trimmer 200 includes a suction fan 228 (schematically illustrated) that draws air in to the openings 224. To prevent the hairs 136 from collecting around the operating portions of the hair trimmer 200, a conduit 240 is formed in the cavity 22 for movement of the hairs 136. The conduit 240 communicates with the openings 224. The fan 228 moves air in through the openings 224, through the conduit 240, past the fan 228, and into a collection chamber 244. The air carries hairs 136 through the conduit 240 as is schematically illustrated in FIG. 8.

The collection chamber (schematically illustrated) includes a filter 248 (e.g., a screen) sized to retain the hairs 136 in the collection chamber until the hairs 136 are cleaned out. The collection chamber 244 is designed to be removed from the body portion 214 for emptying. The filter 248 also allows air to travel out of the collection chamber 244 and through air vents 252. The movement of air is represented in FIG. 8 with arrows. The fan 228 acts as a vacuum to remove excess hairs 136 from the blade set 26, thereby enhancing the reduction or elimination of the hairs 136 from falling on the floor or the person. The vacuum action may also directly remove hairs 136 as they are cut by the blade set 26.

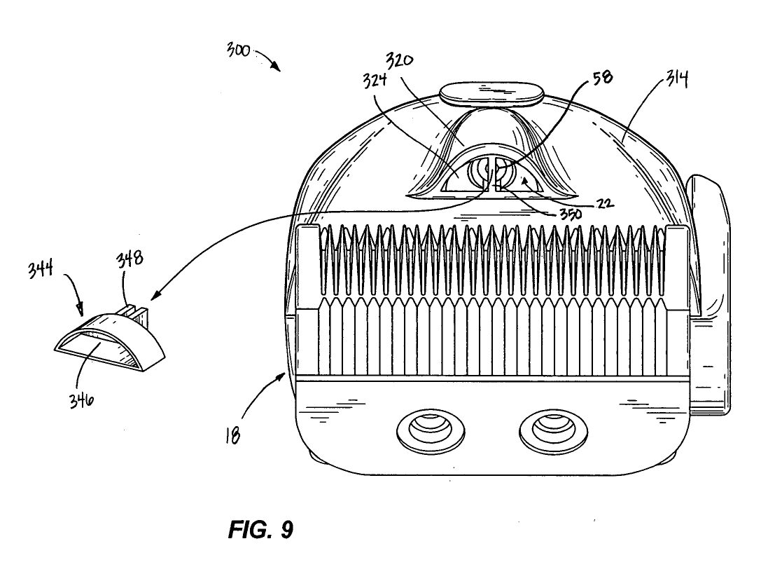

FIG. 9 illustrates a hair trimmer 300. The hair trimmer 300 is similar to the hair trimmers 10, 100 and 200, and like parts are identified using the same reference numerals. The hair trimmer 300 includes a body portion 314 that includes a shroud portion 320. The shroud portion 320 defines an opening 324 that communicates with the inner cavity 22 and opens toward the cutting end 18. The shroud portion 320 is disposed adjacent to the cutting portion of the blade set 26. The electrode 58 of the ion emitter assembly (not shown) housed within the body portion 314 is angled towards the opening 324.

A collection container 344, shown exploded from the hair trimmer 300 is configured and adapted for retention within a portion of the opening 324 of the shroud portion 320. The collection container 344 includes a basin portion 346 for collecting trimmed hairs (not shown) and a rearwardly extending bracket 348 for mounting the collection chamber 344 in the opening 324. In the illustrated embodiment, a wall 350 extends between a top of the shroud portion 320 and the body portion 314. The bracket 348 is coupled to the wall 350 such that the collection container 344 is partially retained within the opening 324 and the basin portion 346 opens toward the cutting end 18 of the hair trimmer 300. It should be readily apparent to those or skill in the art that the collection container 344 may be mounted within the opening 324 using other known methods, such as a press fit, a friction fit, a slot and tab configuration, or the like.

In the illustrated embodiment, ions emitted from the electrode 58 are utilized to charge an energizing point (not shown) rearward of the collection container 344 and within the shroud portion 320 of the trimmer 300. For example, the energizing point may be a portion of the wall 350 positioned within the opening 324. The energizing point is charged for attraction of trimmed hairs (not shown) toward the energizing point. As operation of the hair trimmer 300 continues, a build-up of trimmed hairs may form within the collection container 344 as the hairs are drawn towards the energizing point. In a further embodiment, ions emitted from the electrode 58 are utilized to charge the collection container 344 for attraction of trimmed hairs (not shown) toward the basin portion 346 of the collection container 344. As operation of the hair trimmer 300 continues, a build-up of trimmed hairs may form within the collection container 344. To empty the collection container 344 of trimmed hairs, the collection container 344 is removed from the wall 350 and emptied.

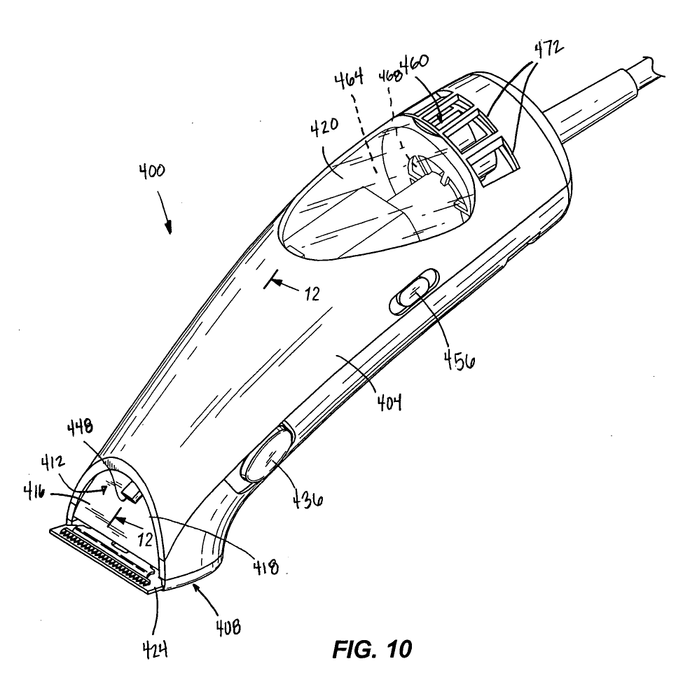

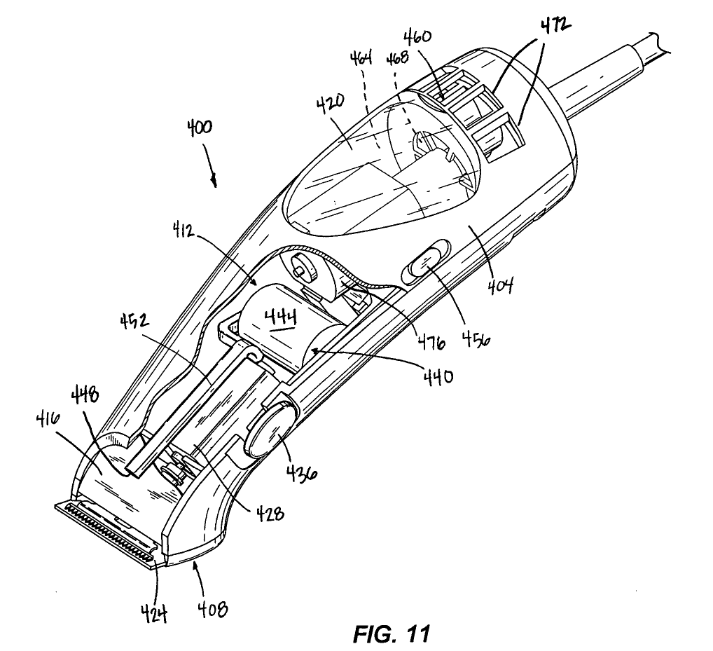

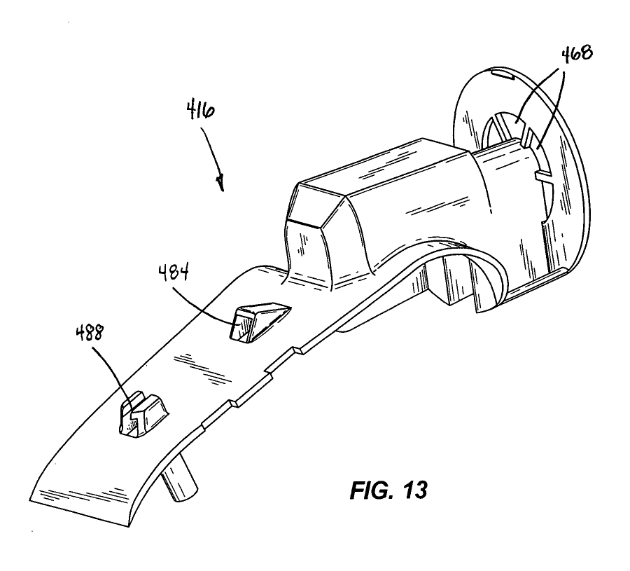

FIGS. 10-12 illustrate a hair trimmer 400. The hair trimmer 400 includes a hollow, elongated body portion 404 having a cutting end 408 and defining an inner cavity 412. A separation member 416, shown in FIG. 13, is disposed in the inner cavity 412 and divides the inner cavity 412 into a first chamber 412A and a second chamber 412B. The body portion 404 defines an opening 418 that communicates with the second chamber 412B of the inner cavity 412 and opens toward the cutting end 408. A door 420 positioned within the body portion 404 provides access to the second chamber 412B. The body portion 404 supports a blade set 424 on the cutting end 408, similar to the blade set 26 discussed above with respect to trimmer 10 shown in FIG. 1. A first electric motor 428 or actuator is mounted in the first chamber 412A and is drivingly connected to the blade set 424 by a drive mechanism 432. A user actuates the first motor 428 by using a power switch 436 provided on the body portion 404.

The hair trimmer 400 includes an ion emitting assembly 440 having an ionizer 444, an ion emitting electrode 448, and an ion lead 452 that electrically couples the ionizer 444 and the electrode 448. In some embodiments, as illustrated, the ionizer 444 is mounted in the first chamber 412A and the electrode 448 is mounted in the second chamber 412B proximate the cutting end 408 and the opening 418. The ion emitting assembly 440 works similarly to the ion emitting assembly 50 discussed above with respect to the trimmer 10 shown in FIG. 1.

For operation, the ionizer 444 receives an ionizer input power from a power source. In the illustrated embodiment, an ionizer switch 456 is provided on the body portion 404. The ionizer switch 456 is configured to interrupt the flow of electrical power (i.e., the ionizer input power) from the power supply to the ionizer 444. Utilization of a separate ionizer switch allows a user to control the ion emitting assembly 440 independent of the first motor 428. The ionizer switch 456 is a three-position switch that allows a user to select between an OFF position, a positive position such that the ionizer 444 emits positive ions, and a negative position such that the ionizer 444 emits negative ions. In a further embodiment, the ionizer switch 456 is a two-position on/off switch, or the ionizer input power may be provided to the ionizer 444 when the user actuates the power switch 436.

The electrode 448 receives the ionizer output voltage from the ionizer 444 via the ion lead 452 and emits ions. The emitted ions may be negative or positive. Although the illustrated electrode 448 is a plate electrode, other embodiments of the electrode 448 may include alternative shapes and sizes.

In one embodiment, the ions emitted by the electrode 448 of the hair trimmer 400 are utilized to charge the blade set 424 for attraction of the trimmed hairs. As the ions are emitted from the electrode 448, the emitted ions collect on the metal blade set 424, thereby charging the blade set 424. The charged blade set 424 attracts objects with an opposite polarity (e.g., the hairs trimmed from a person's hair). As the hairs are trimmed, they are attracted to the blade set 424, thereby reducing or eliminating hairs from falling on the floor or person. The degree of charge on the blade set 424 may be controlled to optimize the amount of hair that is attracted. In other embodiments, the blade set 424 is charged to a degree that repels hair from collecting on the blade set 424, but does not interfere with the hair trimming process.

The hair trimmer 400 includes a vacuum source 460, which is a fan in the illustrated embodiment, although other known vacuum sources may be used. The fan 460 provides a suction force to draw trimmed hairs into the second chamber 412B and to a collection area 464 proximate the door 420. The fan 460 is mounted within the first chamber 412A of the body portion 404 and openings 468 (see FIG. 13) in the separation member 416 permit a suction force to be created in the second chamber 412B to draw in trimmed hairs. The separation member 416 prevents hairs from collecting around the operating portions of the hair trimmer 400. The second chamber 412B forms a conduit for movement of the hairs to the collection area 464 and communicates with the opening 418. In operation, the fan 460 moves air in through the opening 418, through the second chamber 412B, past the fan 460 through the openings 468 in the separation member 416 and out of the hair trimmer 400 through vents 472 formed in the body portion 404. The air carries trimmed hairs through the second chamber 412B to the collection area 464. In a further embodiment, screens or filters cover the openings 468 in the separation member 416 to prevent hairs from entering the first chamber 412A. The fan 460 acts as a vacuum to remove excess hairs from the blade set 424, thereby enhancing the reduction or elimination of the hairs that fall on the floor or the person. The vacuum action may also directly remove hairs as they are cut by the blade set 424.

To remove trimmed hairs from the collection area 464 of the second chamber 412B, the door 420 is removed or opened to access the second chamber 412B. The hair trimmer 400 is then manipulated to empty the trimmed hairs from the collection area 464.

A second electric motor 476 or actuator, is mounted in the first chamber 412A and is drivingly connected to the fan 460 by a drive mechanism 480. The second motor 476 effects operation of the vacuum source 460, which in this embodiment is rotation of the fan. A user actuates the second motor 476 by using the power switch 436 provided on the body portion 404.

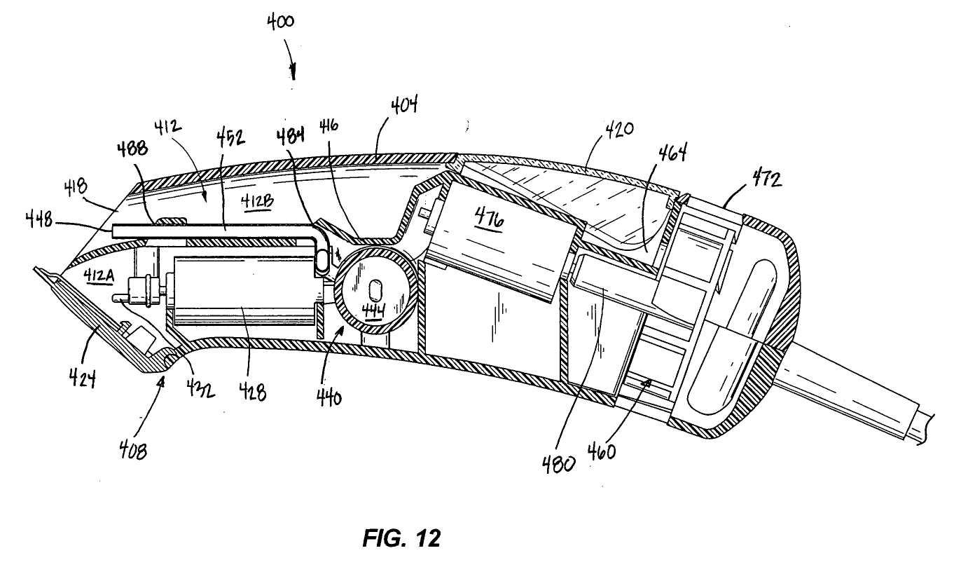

Referring to FIGS. 12 and 13, the separation member 416 is mounted within the inner cavity 412 of the body portion 404 and divides the inner cavity 412 into the first chamber 412A and the second chamber 412B. In the illustrated embodiment, the separation member 416 is a single, molded piece that fits within the body portion 404 to separate the two chambers 412A, 412B. In a further embodiment, the separation member 416 may include a seal to seal the two chambers, and may be comprised of multiple pieces to form the separation member 416.

The separation member 416 is sized and shaped to fit within the body portion 404 of the trimmer 400. In the illustrated embodiment, the separation member 416 is contoured to define housing portions for components of the trimmer 400, such as the first motor 428, the ionizer 444, the second motor 476, and the drive mechanism 480. In a further embodiment, the separation member 416 may have other shapes and sizes depending on the size of the body portion, number of components stored in the body portion, position of the vacuum source, and area required for the second chamber and collection area.

The separation member 416 includes an opening 484 and a channel 488 for accommodating at least the ion lead 452 of the ion emitter assembly 440. As discussed above, the ionizer 444 is positioned within the first chamber 412A of the body portion 404 and the electrode 448 is positioned within the second chamber 412B proximate the opening 418. The ion lead 452 is electrically coupled to the ionizer 444 and passes through the opening 484 into the second chamber 412B. The ion lead 452 then passes along the separation member 416 and through the channel 488, which anchors the ion lead 452 in position such that the electrode 448 is positioned proximate the opening 418.

Other embodiments of the invention may utilize combinations of the above embodiments. Still other embodiments of the invention may utilize ions emitted from the electrode for other hair care purposes.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A hair trimmer comprising:
a body portion having a cutting end, the body portion defining a cavity and an opening communicating with the cavity, wherein the opening is separate from the cutting end;
a blade set mounted adjacent the cutting end;
an ion emitter assembly at least partially mounted within the cavity, wherein ions emitted from the ion emitter assembly flow generally toward the cutting end;
a collection container at least partially disposed within the body portion for collecting trimmed hair as it is cut by the blade set.

2. The hair trimmer of claim 1 wherein the collection container is retained within a portion of the opening and a basin portion of the collection container opens towards the cutting end.

3. The hair trimmer of claim 2 wherein ions emitted from the ion emitter assembly are directed towards an energizing point positioned proximate the opening, and further wherein trimmed hair is drawn towards the energizing point and into the basin portion of the collection container.

4. The hair trimmer of claim 1 wherein the collection container is removable from the body portion.

5. The hair trimmer of claim 1, and further comprising a door positioned in the body portion for accessing the collection container.

6. The hair trimmer of claim 1, and further comprising a suction fan disposed within the cavity for drawing trimmed hair as it is cut by the blade set into the collection chamber, the suction fan in communication with the opening and the collection container via a conduit.

7. The hair trimmer of claim 6 wherein the ion emitting assembly charges the blade set to attract cut portions of trimmed hairs, wherein the trimmed hairs collect on the blade set before being drawn into the collection chamber by the suction fan.

8. The hair trimmer of claim 6, and further comprising a first motor for operating the blade set and a second motor for operating the suction fan.

9. The hair trimmer of claim 1 wherein the ion emitting assembly comprises:
an ionizer adapted to receive an input power and generate an output power based at least in part on the input power; and
an electrode adapted to receive the output power from the ionizer and emit ions toward the blade set.

10. The hair trimmer of claim 1, and further comprising:
a first switch selectable to control the on/off state of the hair trimmer; and
a second switch for controlling the ion emitter assembly.

11. A hair trimmer comprising:
a body portion having a cutting end, the body portion defining a cavity and an opening communicating with the cavity, wherein the opening is separate from the cutting end;
a blade set mounted adjacent the cutting end;
an ion emitter assembly at least partially mounted within the cavity, wherein ions emitted from the ion emitter assembly flow generally toward the cutting end;
a collection chamber at least partially disposed within the body portion; and
a vacuum source disposed within the cavity and in communication with the opening and the collection chamber, the vacuum source for drawing trimmed hair as it is cut by the blade set into the collection chamber.

12. The hair trimmer of claim 11 wherein the vacuum source comprises a suction fan.

13. The hair trimmer of claim 11 wherein the vacuum source is positioned between the collection chamber and the opening.

14. The hair trimmer of claim 11 wherein the ion emitting assembly charges the blade set to attract cut portions of trimmed hairs, wherein the trimmed hairs collect on the blade set before being drawn into the collection chamber by the vacuum source.

15. The hair trimmer of claim 11, and further comprising:
a first switch selectable to control the on/off state of the hair trimmer; and
a second switch for controlling the ion emitter assembly.

16. The hair trimmer of claim 11 wherein the collection chamber is removable from the body portion.

17. The hair trimmer of claim 11, and further comprising a door positioned in the body portion for accessing the collection container.

18. The hair trimmer of claim 11, and further comprising a first motor for operating the blade set and a second motor for operating the vacuum source.

19. The hair trimmer of claim 11, and further comprising a separation member disposed in the cavity and dividing the cavity into a first chamber and a second chamber defining the collection chamber.

20. The hair trimmer of claim 19 wherein the vacuum source is at least partially disposed in the second chamber.

21. The hair trimmer of claim 19 wherein the opening communicates with the second chamber.

22. The hair trimmer of claim 19 wherein the ion emitter assembly is at least partially disposed in the second chamber.

23. A hair trimmer comprising:
a body portion having a cutting end, the body portion defining a cavity and an opening communicating with the cavity, wherein the opening is separate from the cutting end;
a separation member disposed in the cavity for dividing the cavity into a first chamber and a second chamber, wherein the opening communicates with the second chamber;
a blade set mounted adjacent the cutting end;
an ion emitter assembly at least partially mounted within the cavity, wherein ions emitted from the ion emitter assembly flow generally toward the cutting end and through the opening;
a vacuum source disposed within the cavity and in communication with the opening and the second chamber, the vacuum source for drawing trimmed hair as it is cut by the blade set into the second chamber.

24. The hair trimmer of claim 23 wherein the body portion includes a door for accessing the second chamber.

25. The hair trimmer of claim 23, and further comprising a first motor for operating the blade set and a second motor for operating the vacuum source.

26. The hair trimmer of claim 25 wherein the first motor and the second motor are disposed within the first chamber.

27. The hair trimmer of claim 23 wherein the ion emitting assembly comprises:
an ionizer adapted to receive an input power and generate an output power based at least in part on the input power wherein the ionizer is disposed within the first chamber; and
an electrode adapted to receive the output power from the ionizer and emit ions toward the blade set wherein the electrode is at least partially disposed in the second chamber.

28. The hair trimmer of claim 23, and further comprising:
a first switch selectable to control the on/off state of the hair trimmer; and
a second switch for controlling the ion emitter assembly.

29. The hair trimmer of claim 23 wherein polarity of the ions emitted from the ion emitter assembly is user selectable via a polarity switch.

30. The hair trimmer of claim 23 wherein the vacuum source comprises a suction fan.

31. A method of trimming hair using a hair trimmer including a body portion having a cutting end, the body portion defining a cavity and an opening communicating with the cavity, a blade set mounted adjacent the cutting end, an electric motor drivingly connected to the blade set, an ion emitter assembly at least partially mounted within the cavity and coupled to the body portion, a collection chamber at least partially disposed within the body portion, and a vacuum source disposed within the cavity and in communication with the opening and the collection chamber, the method comprising:
powering the electric motor to drive the blade set;
emitting ions from the ion emitter assembly, wherein the ions pass through the opening and flow generally toward the cutting end;
cutting hair with the blade set; and
drawing trimmed hairs into the collection chamber with the vacuum source.

32. The method of claim 31, and further comprising removing the collection chamber from the body portion to empty trimmed hairs from the collection chamber.

33. The method of claim 31, and further comprising filtering air from the cavity of the body portion such that cut portions of trimmed hair are retained within the collection chamber while allowing air to travel out of the collection chamber.

34. The method of claim 31, and further comprising venting air drawn into the cavity by the vacuum source to exit from the hair trimmer.

35. The method of claim 31, wherein the ion emitting assembly charges the blade set to attract cut portions of trimmed hairs so that the hairs collect on the blade set before being drawn into the collection chamber by the vacuum source.

36. The method of claim 31, and further comprising selecting polarity of the ions emitted from the ion emitter assembly.

37. The method of claim 31, and further comprising opening a door on the body portion to access the collection chamber.
